(19) United States
(12) Patent Application Publication
(10) Pub. No.: US 2022/0338590 A1
(43) Pub. Date: Oct. 27, 2022

(54) Nitekap

(71) Applicant: Dheonte T. Moore, Glendale, CA (US)

(72) Inventor: Dheonte T. Moore, Glendale, CA (US)

(21) Appl. No.: 17/238,637

(22) Filed: Apr. 23, 2021

(51) Int. Cl. A42B 1/049; A42B 1/019; A42B 7/00; B32B 3/12; B32B 27/36; B32B 27/08; B32B 27/28

(52) U.S. Cl. CPC A42B 1/049; A42B 1/019; A42B 7/00; B32B 3/12; B32B 27/36; B32B 27/08; B32B 27/281; B32B 2437/04

(57) ABSTRACT

The present utility model relates to a headgear apparel, however the present invention is a night time cap that helps to curb the deficiencies of most shower caps, bonnets, durags and all other forms of headwear. The present invention unlike other prior arts, helps to keep moisturizers, shampoos, and other hair treatment products within the hair preventing leakage, contact with eyes and skin, and also prevent loss of product to the environment of contact such as pillows bed surfaces or other objects of contact while sleeping.

### FIELD OF INVENTION

The present invention relates to a headgear apparel, and more particularly a night cap with three layered materials.

### BACKGROUND OF INVENTION

A shower cap or night cap (also known as a bath cap) is a hat worn while showering or bathing or sleeping to protect hair from becoming wet, loosed, or from any other form of discomfort. Many designs are produced by joining two layers of fabric together in order to make the shower cap not only waterproof but decorative, and comfortable. However, simpler designs are made from one layer of a waterproof material. Designs invariably containing an elastic edging to keep them in place. Shower caps are used in hair mask treatments or hair dyes. They trap in the heat so that the treatment or color sets in. Plastic bags are often used as shower caps. They are important beauty tools in spas. Shower caps are also worn when receiving a facial mask in a spa. We've all used a plastic cap post-wash to deep condition or coils under the dryer. In this case, you don't have to wash or even wet your hair. You simply apply a moisturizer to your hair, cover it in plastic, which can be baggy, plastic cap, or saran wrap, and you let it sit overnight.

The present invention however is a night time cap that helps to curb the deficiencies of most shower caps, night caps, bonnets, durags and all other forms of headwear. The present invention unlike other prior arts, helps to keep moisturizers, shampoos, and other hair treatment products within the hair preventing leakage, contact with eyes and skin, and also prevent loss of product to the environment of contact such as pillows bed surfaces or other objects of contact while sleeping. Most bonnet and shower caps come with just one layered material and doesn't work like the present invention, rather than keep water out, the present invention helps to retains moisture from conditioners, hair treatment shampoos, and other form of hair treatment liquids from getting out of the hair onto surfaces when sleeping.

### DESCRIPTION OF PRIOR ARTS

CN201563681U the utility model relates to a night cap which comprises a cap body. Sound insulation earplugs are arranged inside the cap body in the position corresponding to the position of the ears; buttons are arranged on the two sides of the cap body and connected with a blinder; and a hair sleeve is arranged on the inner surface of the cap body. When in use, the sound insulation earplugs in the cap body can prevent noise and improve the sleeping quality of the user; the blinder on the two sides of the cap body can shield strong light, the hair sleeve on the inner surface of the cap body can enable the hair to be positioned inside when the user sleeps, so as to maintain the hair style. The night cap has the advantages of simple Structure and convenient use, thereby being more convenient to be used by the user when sleeping.

CN201733933U the utility model relates to a nightcap which is characterized by comprising a nightcap body, noise isolation ear bags, and a shading sheet. The nightcap body is made of flexible materials, and the top thereof is provided with a zipper slot having small holes therein; both sides of the nightcap body are fixed with the noise isolation ear bags with the shape similar to that of ears, and the bags are made of noise isolation materials; an opening is arranged at the front of the nightcap body at the position opposite to the eyes; the shading sheet is fixed with the nightcap body for shielding the opening so that the opening is light-proof; the noise isolation ear bags are combined with the shading sheet so as to reduce influences caused by the external noise and light when in sleeping. The nightcap can ensure the sleeping quality, has simple structure and low cost, therefore, the nightcap is suitable for multiple places such as home, hotels and dormitories.

CN201282760Y The utility model relates to a ventilation sunscreen towel and cap, comprising a towel, a cap body, a hidden air opening and a connecting belt, which is characterized in that the towel and the cap bodies are provided with a hidden air opening formed by an air opening and an upper latch sheet, or an upper latch sheet and a lower latch sheet; the edge of the upper latch sheet of the hidden air opening is embedded or packed with rigid material or is coiled with cloth edge, to open the hidden air opening in arc form. The ventilation sunscreen towel and cap has reasonable design, easy manufacture, sunscreen and ventilation property, good effect, and simple application.

U.S. Pat. No. 3,019,444A the utility model reveals a shower cap with a waterproof material adapted to conform to a generally spherical shape, having the means for retaining its free edge in pressured contact with the head of the user and having a plurality of elongated, non-resilient, rigid, hand deformable stiffening members attached to the surface of the material in a pattern extending radially from the center towards the edge, whereby said stiffening members may be deformed so as to vary the free shape.

U.S. Pat. No. 2,730,720A a moldable body patch to provide moisture protection for wound sites. It uses a non-linear shaped preferably medical grade flexible film piece having upper, preferably middle and lower portions and a pull tab permanently adhered to the upper portion of the film piece. A backing paper is removable adhered to the middle portion and to the lower portion which may be removed to reveal an Adhesive that will provide skin adherence in a sealable relationship to prevent underlying wounds from moisture contact. When finished, the film piece may be conveniently removed by pulling on the pull tab permanently adhered to the upper portion of the film piece.

U.S. Pat. No. 6,820,283B2 a Hair washing shower cap and method of manufacture comprising a flexible exterior material laminated with an absorbent interior material and a non-rinse solution on said interior material. The device having an elastic periphery which is capable of elastically constricting about a user's head during use. The device further allows a user to massage the exterior material and easily transfer said massage through said interior material and onto a user's hair or scalp.

CN204427038U A kind of Cap for drying hair, comprises cap body, and the rear end of cap body is provided with one and supplies the front end of cap body through the elasticity fake in order to tighten up cap body. When using, after hair being turned round volume with the cap body of Cap for drying hair, the front end of cap body is rotated inside the elasticity tightening the rear end and then inserting cap body, so coherent action. The utility model improves button in prior art and the structure of buckling fake and match to tighten up Cap for drying hair, adopt the replacement scheme of elasticity fake, this structure improves the dry effect not affecting Cap for drying hair, and the Cap for drying hair degree of tightening up can be regulated, make product be applicable to the head dummy audient of all size more extensive. This Cap for drying hair saves button, simplifies the structure of Cap for drying hair, has saved cost, flexibly more convenient to use. Cap for drying hair good water absorption, does not stay water stain, does not go rotten, do not stain, and has certain antibacterial ability and durable in use

U.S. Pat. No. 3,522,813A This invention relates to a hair and head protecting bonnet, and more particularly to a new and unusual bonnet for protecting hair which has been set and preventing curlers, if still in the hair, from pricking and piercing the head when a person As is well known, it has long been a vexatious and irritating problem for women to treat their hair and place it in curling apparatus prior to the night's sleep, as is by far the most typical procedure, since upon retiring, the pressure of the head as it reclines against the pillow forces the curling apparatus into the scalp. This is an annoying and irritating experience, and may at times actually be painful. Consequently, the manufacturers of curling apparatus have long been concerned with the development of new types of curlers and the like whose purpose is to decrease the discomfort to the wearer under the foregoing conditions, insofar as this is possible. Nonetheless, the problem appears to persist, to cause fitful slumber and Imperfect results from the curling procedure.

U.S. Pat. No. 7,055,179B2 a headwear comprising a substantially circular body securely attached and integral with an annular elasticized absorbent sweatband. The body is sized such that, when the sweatband is fitted over the wearer's forehead, the body forms a cap snugly fitting over the wearer's head. The article of headwear may include a tail piece securely attached to an integral with the rear of the sweatband. Alternatively, the tail piece may be continuous with the body. When the tail piece is included and the headwear is worn, the tail piece drapes down the back of the wearer's head to the shoulders, and extends substantially from the rear of one earlobe to the rear of the other earlobe

U.S. Pat. No. 7,895,672B2. a Bathing cap comprising: a helmet forming a concave zone that ends in a circumferential flange; a resilient margin attached to the helmet along the circumferential flange, the margin and the circumferential flange forming a visible boundary, both the helmet and the resilient margin of a substantially impermeable material; characterized in that a pair of strips, a main strip and a secondary strip, are attached to the margin and extend therefrom from the outside in places corresponding to the location of the user's ears when he wears the cap, where the main strip has a first and a second end, the main strip being attached to the margin at the first end of the main strip; a main fixing mechanism, coupled with the main strip at the second end of the main strip, configured to tighten the margin; the secondary strip has a first and a second end, the secondary strip being attached to the margin at the first end of the secondary strip; a secondary fixing mechanism, coupled to the secondary strip at the second end of the secondary strip, configured to tighten the margin by coupling to the primary fixing mechanism to join the secondary strip with the primary strip, providing the strips when so attached an additional pressure that supports the margin in places where the seal against the wearer's head is the weakest, thereby improving the tightness of the hat.

The present invention aims to provide an effective solution to all the Shortcomings associated with existing night caps, bonnets, shower caps, nylon bags, durags and the aforementioned prior arts. This is made possible with the introduction of multiple layered materials to provide comfort the user, and also prevent leakage. The Invention further consists of an elastic fastening to help secure the hair firmly inside the nightcaps to the head for more stability. The invention also eliminate the need for plastic bags, plastic caps and durags which can be very discomforting to use and most times allows leakage of moisture and liquid from the hair to the skin causing irritation to eyes and skin surfaces.

### SUMMARY OF THE INVENTION

the following summary discloses all the features and functions of the present Invention, by considering the whole specifications, claims, drawings and abstract, one can easily get a full understanding of the invention and how it functions.

The present invention is a night time hair cap that helps to keep moisturizers, shampoos, and other hair treatment products within the hair preventing leakage, contact with eyes and skin that may result to irritation, and also prevent lost or wastage of product to the environment or contact surfaces such as Pillows, bed linings or other objects of contact while sleeping or working. The invention discloses a three layered headgear apparel combined together which further comprises of an elastic band. The three layered material includes the first/outer layer which is made of mesh for comfort of the user, the inner layer/second layer is made of rip stop nylon, which is water and moisture resistant, this helps to keep conditioners, shampoos, relaxers and other hair product tightly secured within the hair to allow for more effectiveness, longer duration of use without spillage to skin or eye. The third layer/inner layer which is also made of mesh all closed by the stretchy headband which is made of satin which helps to keep the night cap firmly on the users head and provide stability during usage.

### BRIEF DESCRIPTIONS OF FIGURES

FIG. 1. Is a side view of the invention

FIG. 2. Is a bottom view of the invention

FIG. 3. Is a top view of the invention/FIG. 4. Is a an exploded view of the materials of the present invention

FIG. 5. Is a side view of the present invention on a user's head.

### DETAILED DESCRIPTION OF FIGURES

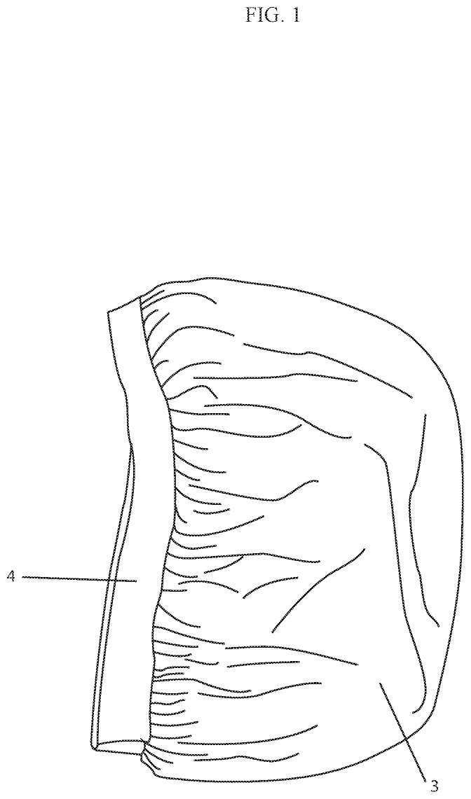

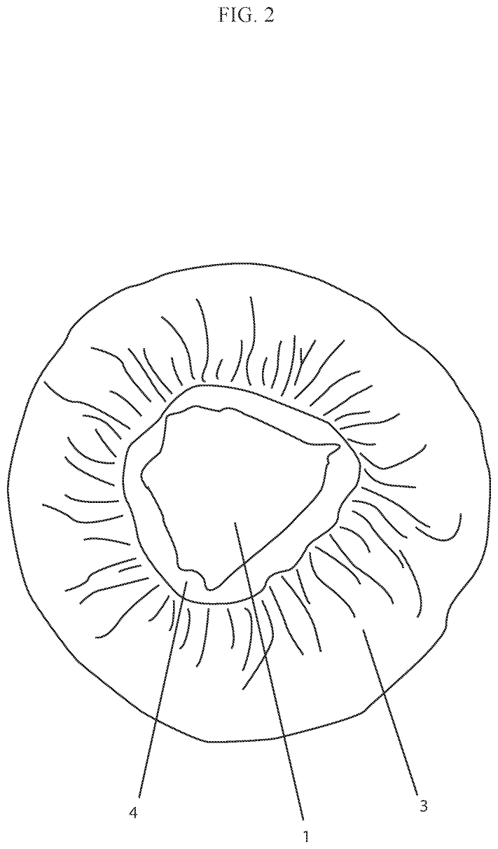

In FIG. 1 a side view of the present invention is disclosed which comprises of the outer layer of the invention (3) made of mesh for comfort and the head band (4) which is made of elastic polyester material that binds the three layers of the nightcap together providing stability and firmness on the users head.

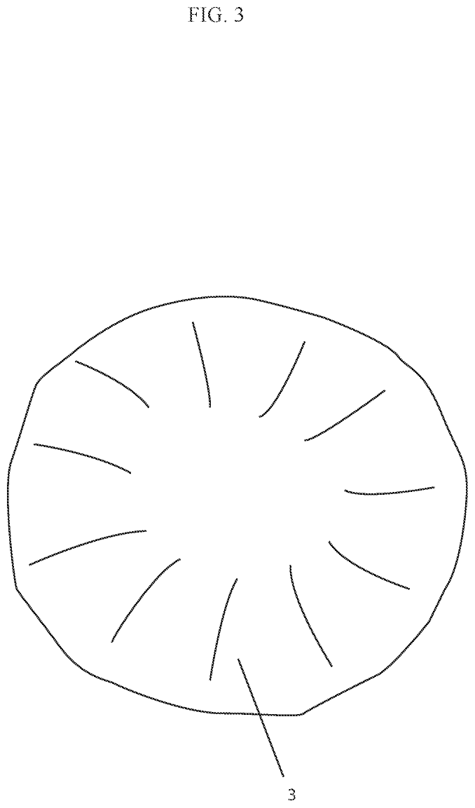

In FIG. 2 a bottom view of the present invention is disclosed which comprises of the outer layer (3) the third/inner layer (1) and the head band (4).

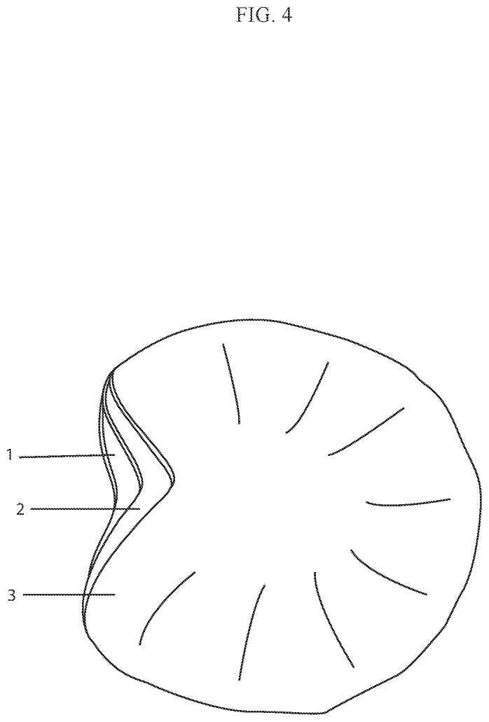

in FIG. 3 a top view of the present invention is disclosed showing the outermost layer (3).

In FIG. 4 the invention discloses an exploded view of the layers of the invention, the first/outward layer (3) which is made of mesh polyester blend, the second/middle layer (2) which is made of rip stop nylon, and the third/inner layer (1) which is made of mesh.

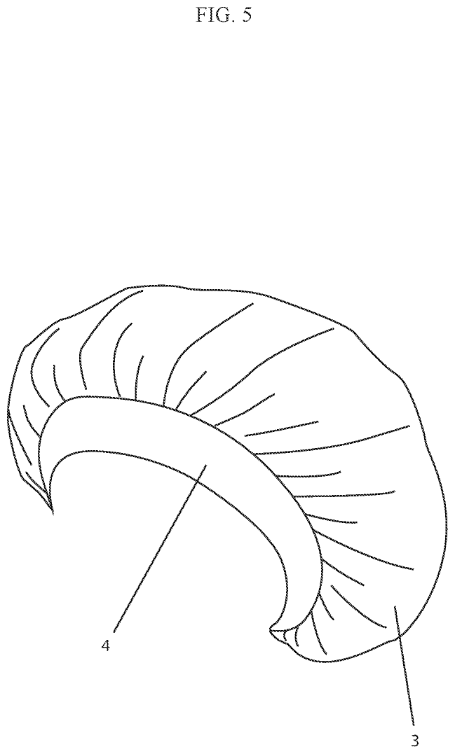

In FIG. 5 the invention is disclosed atop a user's head which comprises of the band (4). And the outer layer (3).

### How the Invention is Used

After application of moisturizer, shampoos, conditioning and other treatments to hair, Flip head upside down, hold the nightcap open with both hands, Hook the nightcap at the nape of your neck Stretch the nightcap downwards, over your hair Press the ends of your hair up towards your scalp to gather it into the nightcap Situate the nightcap and ensure all hair curls or braids are tucked in

Inventions claimed are:

1. A night cap apparel comprising of:
i. a first/outermost layer (3);
ii. a second/middle layer (2), which is attached to the first/outermost layer (3);
iii. a third/inner layer (1), which is further attached to the second/middle layer (2), An elastic band (4), which is further sew to the first/outermost layer (3), Second/middle layer (2) and third/inner layer (1).

2. A night cap apparel as in claim 1) wherein first/outermost layer (3) is made of mesh polyester blend;

3. A night cap apparel as in claim 1), wherein second/middle layer (2) is made of rip stop nylon.

4. A night cap apparel as in claim 1) wherein third/inner layer (1) is made of mesh.

5. A night cap apparel as in claim 1) wherein such elastic band (4) is made of

6. A night cap apparel as in claim 1) which is washable, can be air dried or tumbled dried under low temperature.

7. A night cap apparel as in claim 1) which can keep can keep hair curls or other hairstyles in place while sleeping or working.

8. A night cap apparel as in claim 1) that can fight against humidity. If there is too much moisture in the air, then your hair will get frizzy. That's why you should place a night cap over your hair.

9. A night cap apparel as in claim 1) that can give you the best result for your Deep conditioning. To get the most out of your deep conditioner, it's best to leave it in for a little while. You don't want to walk around your bathroom with hair full of conditioner though. Shampoo your hair like always do, rinse it out, apply the leave-in conditioner, and put on a night cap. The night cap traps the conditioner in so it can work its way into your cuticles.

10. A night cap apparel as in claim 1) that allows you to go on with the rest of your morning routine without worrying about getting conditioner all over the place.

11. A night cap apparel as in claim 1) that allows you keep your hair in place while you sleep. Do you always wake up with a serious bed head going on? Putting on a night cap before you hit the hay can actually prevent this from happening. It will keep your hair in one place while you sleep no matter how much you move around.

12. A night cap apparel as in claim 1) that helps Reduce breakage when you wake up with a head full of tangles, it may take a lot of heavy brushing to work them all out. This forceful Brushing will damage and break your hair. This isn't the only part of your morning routine that is bad for your hair follicles. If you have long hair, the best way to keep it out of your face when you're moisturizing or putting on makeup is to throw it up in a bun. If the bun is too tight, then it can cause hair breakage.

13. A night cap apparel as in claim 1) that Protect your hair treatment. If you get a hair treatment, it will go away if you wet it too often. Hair treatments are way too expensive for you not to get the most out of it. Dying more and more depending on how often you wash it. That means if you want your color to stick around for a while, you should stick to that every 2-3 day rule. The night cap won't only protect your hair color but it will also make it easier to color your hair in the first place. All you've got to do is rub in the color, put on the night cap, and wait.

14. A night cap apparel as in claim 1) that will stop you from having to ruin a towel, and will also prevent the dye Moisturizer, conditioner and other hair treatment from getting on your clothes, pillows or other objects of contact.
